(19) United States
(12) Patent Application Publication
(10) Pub. No.: US 2011/0015328 A1
(43) Pub. Date: Jan. 20, 2011

(54) SEMI AROMATIC POLYAMIDE RESIN COMPOSITIONS, PROCESSES FOR THEIR MANUFACTURE, AND ARTICLES THEREOF

(75) Inventor: Yuji Orihashi, (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E.I.DU PONT DE NEMOURS AND COMPANY, Wilmington, DE (US)

(21) Appl. No.: 12/837,533

(22) Filed: Jul. 16, 2010

Related U.S. Application Data
(60) Provisional application No. 61/226,346, filed on Jul. 17, 2009.

(51) Int. Cl. C08L 77/00; C08K 3/34

(52) U.S. Cl. 524/443; 525/184; 524/514; 524/451

(57) ABSTRACT

The present invention relates to a high temperature polyamide resin composition for moulded articles, articles formed therefrom and processes for producing the composition, comprising: semi-aromatic polyamide with a melt temperature above 280° C. and one or more oxidized polyethylene lubricants as internal lubricant.

### CROSS REFERENCE TO RELATED APPLICATIONS

This application claims the benefit of priority to U.S. Provisional Application No. 61/226,346, filed Jul. 17, 2009.

### FIELD OF THE INVENTION

The present invention relates to semi-aromatic polyamide resin compositions. More specifically, it relates to semi-aromatic polyamide resin compositions comprising a semi-aromatic polyamide resin and an internal lubricant, processes for their manufacture, and articles thereof.

### BACKGROUND OF THE INVENTION

Because of their excellent mechanical and electrical insulation properties, thermoplastic polymeric resin compositions are used in a broad range of applications such as in automotive parts, electrical and electronic parts, machine parts and the like. Typically they are formed into various parts and shapes by melt forming. This typically involves melting of the thermoplastic polymeric resin composition, forming it while molten into a shape and then cooling the composition to a solid to fix it in that shape. In most melt forming machines, the composition is fed in the form of a pellet or granule, typically in the size range of 0.1 to about 0.7 cm (longest dimension). In order for most melt forming machines to work efficiently, it is preferred that the pellets or granules be free flowing and have a reasonably uniform size.

In general, release agents that act as a lubricant, are applied by blending, adhering by melting lubricant on hot pellets, spraying, wiping or brushing onto the surface of pellets, for example fatty acid metal salts such as zinc stearate and calcium stearate.

However because the fatty acid metal salts as an external lubricant is subject to heat and pressure during molding, mold deposition is evident on the resulting mold tool. In addition, the lubricant is sometimes peeled off (separated out) from pellets during delivery by friction among pellets. Furthermore, the content of such external lubricant varies from lot to lot, and consequently, ejectability is not satisfactory given the often stringent and exacting molding requirements.

In response to these concerns, high temperature polyamides incorporating release agents have been used and are generally satisfactory for conventional applications. However, there is increasingly a demand for higher temperature (>280° C.) applications that have more stringent property requirements than those of current polyamides in the industry.

Semi-aromatic polyamide resin blends that exhibit greater dimensional stability in the presence of moisture, greater heat resistance, and greater chemical resistance are disclosed in EP 0 696 304 and EP 0 741 762. The compositions disclosed in these patents include semi-aromatic polyamide resins having an aromatic carboxylic acid component such as terephthalic acid or a mixture of terephthalic acid and isophthalic acid, and an aliphatic diamine component derived from a mixture of hexamethylene diamine and 2-methylpentamethylene diamine. Unfortunately, these resins cannot be used for making blow molded articles due to their low strength when in a molten state (melt strength), their rapid rate of crystallization, and their tendency to form bubbles during a blow molding process.

A need exists for a high temperature polyamide that can withstand higher melting temperatures without the formation of mold deposition and the peeling off of lubricant from pellets while improving ejectability.

There has also been a strong desire for high temperature polyamide resin compositions that do not experience mold deposition and are able to improve ejectability during molding and minimize the content of release agents.

It is desirable for the present invention to provide high temperature polyamide resin compositions, which contain a thermoplastic resin and a lubricant. It is also desirable that the present invention provides articles shaped from such compositions, and processes for their manufacture.

### SUMMARY OF THE INVENTION

In one aspect of this invention, there is a high temperature polyamide resin composition comprising: (a) about 40 to about 90 weight percent, based on the total composition, of semi-aromatic polyamides with a melt temperature above 280° C. and (b) one or more oxidized polyethylene lubricants with low average molecular weight about 1800 to about 2200, a melt viscosity at 140° C. and a shear rate of 100 sec-1 of 1500 to 2000 mPa sec, and acid ends of 15 to 24 mg KOH/g, wherein the total amount of lubricant present in the composition is between about 0.1 to about 0.6 weight percent, based on the total weight of the composition.

Another aspect of the present invention includes a process for producing the high temperature polyamide resin composition of the present invention.

A further aspect of the present invention includes producing a shaped article from the polyamide resin composition of the present invention. The shaped articles include, but are not limited to, for example, molded articles.

### DETAILED DESCRIPTION OF THE INVENTION

The resin composition of the invention comprises semi-aromatic polyamide with a melt temperature above 280° C. and oxidized polyethylene lubricant with low average molecular weight about 1800 to about 2200 which is incorporated in compound internally.

The polyamide composition used in the present invention has a melting point of at least 280° C. and comprises: (a) about 40 to about 90 weight percent, based on the total composition, of aromatic polyamide polymer or copolymer having repeating units derived from a carboxylic acid component and an aliphatic diamine component. The carboxylic component is terephthalic acid or a mixture of terephthalic acid and one or more other carboxylic acids wherein the carboxylic acid component contains at least 55 mole percent, based on the carboxylic acid component, of terephthalic acid, and the aliphatic diamine component is hexamethylene diamine or a mixture of hexamethylene diamine and 2-methyl pentamethylene diamine or 2-ethyltetramethylene diamine, in which the aliphatic diamine component contains at least 40 mole percent, based on the aliphatic diamine component, of hexamethylene diamine. The polyamide composition further comprises (b) about 0.1 to about 0.6 weight percent, based on the total composition, of one or more oxidize polyethylene lubricant with low average molecular weight about 1800 to about 2200.

Additionally, depending on the desired application, lubricant such as polyethylene is included in compositions made from these polymeric materials to be compounded before molding with the compositions, which is known as an “internal lubricant” and the use of lubricant such as the fatty acid metal salts onto the surface of pellets as being distinguished from the internal lubricant, which is also known as an external lubricant to a person of ordinary skill in the art. In the present invention, the lubricant can be blended with other polymeric materials as the internal lubricant.

The resin composition incorporates about 0.1 to about 0.6 weight percent, preferably about 0.2 to about 0.5 weight percent (of the total composition) of lubricant. Many types of materials are sold as lubricants, and in the present compositions due regard should especially be given to their effects on mold release, as well as other physical properties. Lubricants (b) of the resin composition of the present invention may be polar or non-polar ingredients. For instance one type of preferred lubricant is polyethylene (PE) wax, a polyethylene wax usually having a number average molecular weight of about 1,000 to about 5,000. The end groups on these waxes may be non-polar (for instance methyl ends). Polar polyethylene wax is oxidized polyethylene having carboxylic acid group at the end group and or branched side chain end. Oxidized polyethylene typically has a number average molecular weight (MW) of about 1000 to 2500. Level of oxidization, in other words, number of carboxylic acid group, can be controlled at reaction. For both non-polar and polar polyethylene waxes there are two types of polyethylene regarding polymerization procedure. One is linear polyethylene polymerized under low pressure with Ziegler catalyst. The other is low density polyethylene (LDPE) polymerized under high pressure with radical catalyst. Such waxes are commercially available; see for instance the Licowax brand product line, available from Clariant Corp., Charlotte, N.C. 28205, USA. In some compositions non-polar lubricants such as Licowax® PE 520 or PE 190 are preferred as linear PE, and Licowax® PE830 or 840 as LDPE is preferred. On the other hand, polar lubricants (b) such as Licowax® PED 521 or PED 522 is preferred as linear PE, and PED 821 or PED 822 can be also used as LDPE. High density polyethylene (HDPE) is one of linear polyethylene. Clariant provides Licowax PED 136 or PED 191 as polar HDPE. These waxes are used as internally lubricant. In other words, lubricant (b) is incorporated in compound internally at compounding.

The desired lubricant (b) of the resin composition of the present invention contain the polar end and/or side groups of which at least a part thereof with a conventional neutralizing agent, e. g., an organic monocarboxylic acid, corresponding to an acid value of 15 to 24 mg KOH/g.

The lubricant used in the present invention has a melt viscosity from 200 to 25000 mPa sec measured at 140° C. and a shear rate of 100 sec-1. Preferably lubricant has a melt viscosity of at least 1500 to 2000 mPa sec measured at 140° C. and a shear rate of 100 sec-1. Examples of suitable low molecular weight oxidized polyethyelene lubricant include Licowax® PED 191 and PED192. The low molecular weight oxidized polyethylene lubricants that are particularly preferred have number average molecular weight that are at least about 1800 to about 2200, more preferably about 1950 to about 2050 and most preferably about 2000.

The lubricant (b) used in the invention is present in composition of the present invention in about 0.1 to about 0.6 weight percent, or preferably about 0.2 to about 0.5 weight percent, based on the total weight of the composition. This allows the composition to be molded under standard molding conditions and the shaped articles obtained therefrom are able to be applied for industry applications such as automobile parts.

The composition of the present invention may further comprise additives such as colorants, plasticizers, oxidative stabilizers, light stabilizers, thermal stabilizers, fillers, reinforcing agents, impact modifiers, flame retardants, and the like.

The compositions of the present invention can be prepared by melt-blending the semi-aromatic polyamide and the lubricant with a conventional device such as a roll mill or extruder.

The compositions of the present invention can be processed into shaped articles by ordinary melt-processing techniques such as injection molding, compression molding, extrusion or blow molding. The lubricant releases molded article from the tool without placing undue stress on molded parts that may occur at instances where ejector pins are pushing the part. In addition, even after accumulating mold shots, no mold deposition on the tool is observed.

The compositions have a low resistance to ejectability in a mold and produce no mold deposit, both properties being very desirable attributes for an injection molding composition. Low resistance to ejectability herein means the composition exhibits less than 150 kg/cm², and preferably less than 100 kg/cm², when measured according to the method disclosed herein.

### EXAMPLES

The invention is further illustrated by the following examples. It will be appreciated that the examples are for illustrative purposes only and are not intended to limit the invention as described above. Modification of detail may be made without departing from the scope of the invention.

### Materials

The individual components in the molding compositions described in the examples below were as follows:

Polyamide 6T/DT is an aromatic polyamide derived from a carboxylic acid component that is 100% terephthalic acid, and the aliphatic diamine component that is a mixture of hexamethylene diamine and 2-methyl pentamethylene diamine, available under the tradename Zytel® HTN 501 from E. I. du Pont de Nemours and Company (“DuPont”).

Polyamide 6T/66 is a copolyamide made from terephthalic acid, adipic acid, and hexamethylenediamine; wherein the two acids are used in a 55:45 molar ratio; having a melting point of ca. 310° C., having an inherent viscosity (IV), according to ASTM D2857 method, in the range of 0.9 to 1.0 (typically 0.96) available from E.I. DuPont de Nemours and Company, Wilmington, Del., USA under the trademark Zytel® HTN 502.

Glass Fibers are E-glass, G-filament, approximately 10 micron diameter, approximately 3 mm length, amino-silane coated glass fibers.

Chimasorb® 8944 (Ciba Geigy Corp.)is an oligomeric hindered amine light stabilizer: Poly [[6-[(1,1,3,3-tetramethylbutyl) amino]-1,3,5-triazine-2,4-diyl] [(2,2,6,6-tetramethyl-4- piperidinyl) imino]-l,6-hexanediyl[(2,2,6,6-tetramethyl-4-piperidinyl) imino]]).

Irgafos® 168 (Ciba Geigy Corp.)is a phosphite processing stabilizer: Tris (2,4-ditert-butylphenyl) phosphite.

Irganox® 1098 is a phenolic primary antioxidant for processing and long-term thermal stabilization: N-N′-hexane-1,6-diylbis (3-(3,5-di-tert-butyl-4-hydroxyphenylpropionamide)).

Ultranox® 626 (from GE Specialty Chemicals)is a phosphite antioxidant, bis(2,4-di-tert-butylphenyl)pentaerythritol diphosphite.

Characteristics of polyethylene lubricants used were summarized in Table 1.

TABLE 1
Characteristics of lubricant^{a}

| | | Dropping | | | |
|---|---|---|---|---|---|
| | PE | point | Acidity | MV | |
| | type | (° C.) | (mgKOH/g) | (mPa sec) | Mn |
| Licowax ® | HDPE | 120-125 | 15-19 | 2000 (140° C.) | 2000 |
| PED191 | | | | | |
| Licowax ® | Linear | 103-105 | 15-19 | 350 (120° C.) | 1150 |
| PED521 | PE | | | | |
| Licowax ® | Linear | 102-107 | 22-28 | 300 (120° C.) | 1000 |
| PED522 | PE | | | | |
| Licowax ® | HDPE | 120-125 | 20-23 | 1500 (140° C.) | 2000 |
| PED192 | | | | | |
| Licowax ® | HDPE | 117-122 | 22-27 | 1700 (140° C.) | 1600 |
| PED153 | | | | | |
| Licowax ® | HDPE | 108-113 | 57-64 | 300 (120° C.) | 900 |
| PED136 | | | | | |
| Licowax ® | Linear | 113-118 | 16-19 | 200 (140° C.) | 1100 |
| PED121 | PE | | | | |
| Licowax ® | Linear | 132-138 | 0 | 25000 (140° C.) | 5500 |
| PE190 | PE | | | | |

^{a} all lubricants were available from Clariant Corporation.

### Methods

The compositions of the examples were made by compounding the components using a laboratory scale twin screw extruder, wherein the temperature of the melt was 340° C., the screw speed was 350 rpm and the average volumetric flow rate was 80 kg/hr. The compositions of the examples 1-5 and comparative example C1-C12 and their properties are set forth below in Table 2-4.

The resultant resin compositions were used to mold 4 mm ISO all-purpose bars. Molding machine used was JSW 100E2-P with melt temperature of 320° C. and mold temperature of 150° C. The test pieces were used to measure mechanical properties on samples at 23° C. and dry as molded. The following test procedures were used:

Tensile strength and elongation at break : ISO 527-1/2

Flexural modulus and strength: ISO 178

Charpy impact strength (N-Charpy): ISO standard test 179/leA)

DTUL (Heat Deflection Temperature): ISO 75.

Resistance to Ejectability

Ejectability was measured as resistance of molded part from tool. A part was a bobbin shape having outer diameter of 32 mm with 0.75 mm thickness. A pressure sensor was placed behind the ejector pin (2 mm diameter). The signal was magnified by amplifier and recorded on a personal computer through ND board.

Mold Deposition

Mold deposition on the molding tool was visually observed after 300 shots. Molded part is a 60 mm×70 mm×0.8 mm thickness plate.

TABLE 2

| Examples | 1 | C1 | C2 | 2 | C3 |
|---|---|---|---|---|---|
| Polyamide 6T/DT | 63.3 | 63.3 | 63.3 | 63.3 | 63.3 |
| Glass fiber | 35 | 35 | 35 | 35 | 35 |
| Talc | 0.35 | 0.35 | 0.35 | 0.35 | 0.35 |
| Chimasorb ® 944 | 0.3 | 0.3 | 0.3 | 0.3 | 0.3 |
| Ultranox ® 626 | 0.1 | 0.1 | 0.1 | 0.1 | 0.1 |
| Irganox ® 1098 | 0.75 | 0.75 | 0.75 | 0.75 | 0.75 |
| Licowax ® PED191 | 0.2 | | | | |
| Licowax ® PED521 | | 0.2 | | | |
| Licowax ® PED522 | | | 0.2 | | |
| Licowax ® PED192 | | | | 0.2 | |
| Licowax ® PED153 | | | | | 0.2 |
| Physical Properties | | | | | |
| Tensile strength (MPa) | 224 | 218 | 218 | 222 | 220 |
| Elongation at break (%) | 2.6 | 2.5 | 2.5 | 2.5 | 2.5 |
| Flexular strength (MPa) | 305 | 301 | 300 | 298 | 301 |
| Flexular modulus (MPa) | 10693 | 10705 | 10726 | 10748 | 10764 |
| Notched Charpy (kJ/m²) | 10.6 | 10.4 | 10.5 | 10.5 | 10.6 |
| DTUL (° C.) | 265 | 265 | 264 | 265 | 265 |
| Resistivity at ejection | 71 | 175 | 138 | 74 | 148 |
| (kg/cm²) | | | | | |
| Mold deposition | no | na | na | no | na |

na = not available

TABLE 3

| Examples | C4 | C5 | C6 | 3 | 4 | C7 |
|---|---|---|---|---|---|---|
| Polyamide | 63.3 | 63.3 | 63.3 | 63.3 | 63.3 | 63.5 |
| 6T/DT | | | | | | |
| Glass fiber | 35 | 35 | 35 | 35 | 35 | 35 |
| Talc | 0.35 | 0.35 | 0.35 | 0.35 | 0.35 | 0.35 |
| Chimasorb ® | 0.3 | 0.3 | 0.3 | 0.3 | 0.3 | 0.3 |
| 944 | | | | | | |
| Ultranox ® | 0.1 | 0.1 | 0.1 | 0.1 | 0.1 | 0.1 |
| 626 | | | | | | |
| Irganox ® | 0.75 | 0.75 | 0.75 | 0.75 | 0.75 | 0.75 |
| 1098 | | | | | | |
| Licowax ® | 0.30 | 0.40 | | | | |
| PED191 | | | | | | |
| Licowax ® | 0.2 | | | | | |
| PED136 | | | | | | |
| Licowax ® | | 0.2 | | | | |
| PED121 | | | | | | |
| Licowax ® | | | 0.2 | | | |
| PE190 | | | | | | |
| Calcium | | | | | | 0.2 |
| Montanate | | | | | | |
| Physical | | | | | | |
| Properties | | | | | | |
| Tensile | 216 | 217 | 221 | 219 | 215 | 224 |
| strength (MPa) | | | | | | |
| Elongation at | 2.5 | 2.5 | 2.6 | 2.6 | 2.5 | 2.6 |
| break (%) | | | | | | |
| Flexular | 298 | 300 | 303 | 298 | 300 | 306 |
| strength (MPa) | | | | | | |
| Flexular | 10708 | 10725 | 10702 | 10505 | 10461 | 10698 |
| modulus (MPa) | | | | | | |
| Notched | 10.2 | 10.4 | 10.5 | 10.3 | 10.4 | 10.5 |
| Charpy (kJ/m²) | | | | | | |
| DTUL (° C.) | 264 | 264 | 264 | 267 | 265 | 264 |
| Resistivity at | 335 | 165 | 460 | 32 | 5.7 | 49 |
| ejection | | | | | | |
| (kg/cm²) | | | | | | |
| Mold | na | na | na | na | no | yes |
| deposition | | | | | | |

na =not available

Example 1-4 with Licowax® PED 191 or PED 192, as internal lubricant, and the comparative example C7 with external calcium montanate showed low resistivity at ejection, that is, less than 150 kg/cm².

Samples with low resistivity at ejection, good ejectability, were tested for mold deposition. No mold deposition on tool was observed for example 1-4. On the other hand, deposition was observed for the comparative example C7. IR absorption analysis revealed that deposition was calcium montanate.

TABLE 4

| Examples | C8 | 5 | C9 | C10 | C11 | C12 |
|---|---|---|---|---|---|---|
| Polyamide | 63.65 | 63.65 | 63.65 | 63.65 | 63.65 | 63.65 |
| 6T/66 | | | | | | |
| glass fiber | 35 | 35 | 35 | 35 | 35 | 35 |
| Chimasorb ® | 0.3 | 0.3 | 0.3 | 0.3 | 0.3 | 0.3 |
| 944 | | | | | | |
| Ultranox ® | 0.1 | 0.1 | 0.1 | 0.1 | 0.1 | 0.1 |
| 626 | | | | | | |
| Irganox ® | 0.75 | 0.75 | 0.75 | 0.75 | 0.75 | 0.75 |
| 1098 | | | | | | |
| Licowax ® | 0.2 | | | | | |
| PE190 | | | | | | |
| Licowax ® | | 0.2 | | | | |
| PED191 | | | | | | |
| Licowax ® | | | 0.2 | | | |
| PED521 | | | | | | |
| Licowax ® | | | | 0.2 | | |
| PED522 | | | | | | |
| Licowax ® | | | | | 0.2 | |
| PED153 | | | | | | |
| Licowax ® | | | | | | 0.2 |
| PED136 | | | | | | |
| Resistivity at | 364 | 119 | 179 | 197 | 180 | 372 |
| ejection | | | | | | |
| (kg/cm²) | | | | | | |
| Mold | no | no | no | yes | yes | yes |
| deposition | | | | | | |

In polyamide 6T166 examples listed in Table 4, Example 5, with Licowax PED 191 showed lowest resistivity at ejection, and with no mold deposit. Thus, for polyamide 6T/DT and polyamide 6T166, oxidized polyethylene wax having number average molecular weight that is about 1800 to about 2200 is effective as mold release without mold deposition.

1. A high temperature polyamide resin composition comprising: (a) about 40 to about 90 weigh percent, based on the total composition, of semi-aromatic polyamides with a melt temperature above 280° C. and (b) one or more oxidized polyethylene lubricants with low average molecular weight about 1800 to about 2200, a melt viscosity at 140° C. of 1500 to 2000 mPa sec, and acid ends of 15 to 24 mg KOH/g, wherein the total amount of lubricant present in the composition is between about 0.1 to about 0.6 weight percent, based on the total weight of the composition.

2. The composition of claim 1, wherein said semi-aromatic polyamide is derived from a carboxylic acid component that is terephthalic acid and optionally, one or more additional aliphatic carboxylic acids, and the aliphatic diamine component is hexamethylene diamine or a mixture of hexamethylene diamine and 2-methyl pentamethylene diamine

3. The composition of claim 1, further comprising one or more additives selected from the group consisting of glass fiber, talc, wollastonite, heat stabilizer, antioxidant, and impact modifier.

4. A shaped article made from the composition of claim 1.

5. The article of claim 4 in the form of compounded pellet and containing one or more of glass fiber, heat stabilizer, antioxidant, and light stabilizer.

6. A process for the manufacture of a composition comprising: (a) semi-aromatic polyamides and (b) one or more oxidized polyethylene lubricants with low average molecular weight of about 1800 to about 2200, a melt viscosity at 140° C. of 1500 to 2000,and acid ends of 15 to 24, wherein said composition comprising(a) about 40 to about 90 weigh percent, based on the total composition, of semi-aromatic polyamides with a melt temperature above 280° C.; and the total amount of (b) lubricant present in the composition is between about 0.1 and about 0.6 weight percent, based on the total weight of the composition; said process comprising the steps of: (i) in a first mixing step mixing materials comprising said semi-aromatic polyamide and said lubricant to form an intermediate composition ; and then (ii) in a subsequent mixing step introducing and mixing the intermediate composition of step (i) In a twin screw extruder, and optionally other ingredients, while said intermediate composition is molten.
